(19) United States
(12) Patent Application Publication
(10) Pub. No.: US 2022/0176772 A1
(43) Pub. Date: Jun. 9, 2022

(54) RECREATIONAL VEHICLE AIR CONDITIONER AND CONTROL METHOD THEREOF

(71) Applicant: Guangdong Giwee Technology Co. Ltd., Foshan (CN)

(72) Inventors: Min Zhou, Foshan (CN); Zhicheng Pu, Foshan (CN)

(21) Appl. No.: 17/545,052

(22) Filed: Dec. 8, 2021

(30) Foreign Application Priority Data
Dec. 9, 2020 (CN) 202011426010.3

(51) Int. Cl. B60H 1/00

(52) U.S. Cl. CPC B60H 1/0075; B60H 1/00821; B60H 1/00364

(57) ABSTRACT

An air conditioning unit and a control method. The control method includes the following: S1. detecting the operation status of an air conditioner; S2. acquiring, by photosensitive sensors, the sunlight conditions of a recreational vehicle in parking; and S3. adjusting, by a control module, air outlet areas of the air conditioning unit for the recreational vehicle according to the acquired sunlight conditions and the sunlight exposure side of the recreational vehicle in parking. The control method can adjust the air outlet areas of the air conditioner by checking the operation status of the air conditioner and acquiring the sunlight conditions of the recreational vehicle in parking through the photosensitive sensors, thereby improving the user's sense of comfort.

### FOREIGN PRIORITY

This application claims priority to Chinese Patent Application No. 202011426010.3, filed Dec. 9, 2020, and all the benefits accruing therefrom under 35 U.S.C. § 119, the contents of which in its entirety are herein incorporated by reference.

### TECHNICAL FIELD

Embodiments of the present disclosure relate to the field of control of air conditioners for recreational vehicles, and in particular to an air conditioning unit for a recreational vehicle and a control method thereof.

### BACKGROUND

A recreational vehicle is constructed with glass on all of the four sides; and with sunlight, there is a huge temperature difference between a side surface exposed to sunlight and a side surface not exposed to sunlight in the recreational vehicle. Similar to common air conditioners, existing air conditioners for recreational vehicles supply air downward in normal conditions, or supply air at artificially fixed angles. Conventional design does not consider the sunlight-induced temperature difference in a recreational vehicle, thus the temperature in the recreational vehicle cannot be reduced in a timely manner, the area in need of fast cooling cannot be quickly cooled, and the temperature in the recreational vehicle cannot be balanced rapidly, or an opposite effect is caused on the temperature balance in the recreational vehicle, thereby impairing the use.

### SUMMARY

With respect to the problems in the prior art, the present invention provides an air conditioning unit for a recreational vehicle and a control method thereof. In the present invention, the refrigeration air outlet direction of the air conditioner for the recreational vehicle can be controlled according to the sunlight direction of the recreational vehicle in parking, so as to quickly balance the temperature in the recreational vehicle.

To solve the above-mentioned technical problem, the present invention provides the following technical solution: In a first aspect, the present invention provides a control method of an air conditioning unit for a recreational vehicle, comprising the following steps: S1. detecting the operation status of an air conditioner; S2. acquiring, by photosensitive sensors, the sunlight conditions of the recreational vehicle in parking; and S3. adjusting, by a control module, air outlet areas of the air conditioning unit for the recreational vehicle according to the acquired sunlight conditions and the sunlight exposure side of the recreational vehicle in parking.

Further, the photosensitive sensors are divided into a first photosensitive sensor, a second photosensitive sensor and a third photosensitive sensor.

Further, the air outlet coverage of the air conditioning unit for the recreational vehicle is divided into a first air outlet area, a second air outlet area and a third air outlet area.

Further, the step S1 specifically comprises: refrigerating the second air outlet area first by the air conditioning unit for the recreational vehicle when the air conditioning unit for the recreational vehicle detects that the air conditioner is in refrigeration.

Further, the first photosensitive sensor is located in the first air outlet area, the second photosensitive sensor is located in the second air outlet area, and the third photosensitive sensor is located in the third air outlet are, wherein the step S3 specifically comprises: controlling, by the control module, the air conditioning unit for the recreational vehicle to refrigerate the first air outlet area when the resistance value of the first photosensitive sensor is the smallest, which indicates that the sunlight exposure side of the recreational vehicle is on the first photosensitive sensor; controlling, by the control module, the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and controlling, by the control module, the air conditioning unit for the recreational vehicle to refrigerate the third air outlet area when the resistance value of the third photosensitive sensor is the smallest, which indicates that the sunlight exposure side of the recreational vehicle is on the third photosensitive sensor.

In a second aspect, the present invention provides an air conditioning unit for a recreational vehicle, comprising: a detection module, configured to detect the operation status of an air conditioner for a recreational vehicle; photosensitive sensors, configured to acquire the sunlight conditions of the recreational vehicle in parking; and a control module, configured to adjust air outlet areas of the air conditioning unit for the recreational vehicle according to the sunlight exposure side and the sunlight conditions of the recreational vehicle acquired by the photosensitive sensors.

Further, the control module is connected to the photosensitive sensors and the detection module.

Further, the photosensitive sensors are divided into a first photosensitive sensor, a second photosensitive sensor and a third photosensitive sensor.

Further, the air outlet coverage of the air conditioning unit for the recreational vehicle is divided into a first air outlet area, a second air outlet area and a third air outlet area.

Further, the first photosensitive sensor is located in the first air outlet area, the second photosensitive sensor is located in the second air outlet area, and the third photosensitive sensor is located in the third air outlet are, wherein the control module controls the air conditioning unit for the recreational vehicle to refrigerate the first air outlet area when the resistance value of the first photosensitive sensor is the smallest, which indicates that the sunlight exposure side of the recreational vehicle is on the first photosensitive sensor; the control module controls the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and the control module controls the air conditioning unit for the recreational vehicle to refrigerate the third air outlet area when the resistance value of the third photosensitive sensor is the smallest, which indicates that the sunlight exposure side of the recreational vehicle is on the third photosensitive sensor.

It can be seen from the above technical solution that, in the control method of an air conditioning unit for a recreational vehicle provided by the present invention, the air conditioning unit for the recreational vehicle first detects the operation status of the air conditioner, then acquires the sunlight conditions of the recreational vehicle in parking by the photosensitive sensors, and finally adjusts the air outlet areas of the air conditioning unit for the recreational vehicle according to the acquired sunlight conditions and the sunlight exposure side of the recreational vehicle in parking by using the control module. Thus, in the present invention, the refrigeration air outlet direction of the air conditioner for the recreational vehicle can be controlled according to the sunlight direction of the recreational vehicle in parking, so as to quickly balance the temperature in the recreational vehicle.

### BRIEF DESCRIPTION OF THE DRAWINGS

In order to more clearly describe the embodiments of the present invention or the technical solution of the prior art, a brief introduction of the drawings used for the description of the embodiments or the prior art is made below. Apparently, the drawings described below are some embodiments of the present invention; and other drawings can be obtained by those of ordinary skill in the art according to these drawings without creative efforts.

FIG. 1 is a flow chart of a control method of an air conditioning unit for a recreational vehicle according to the present invention;

FIG. 2 is a schematic diagram illustrating air outlet areas in the control method of an air conditioning unit for a recreational vehicle according to the present invention;

FIG. 3 is a schematic diagram illustrating a structure of the air conditioning unit for the recreational vehicle according to the present invention;

FIG. 4 is a schematic diagram illustrating the connection of the photosensitive sensors of the air conditioning unit for the recreational vehicle according to the present invention.

### DETAILED DESCRIPTION

To make clearer the objectives, technical solutions and advantages of the embodiments of the present invention, a clear and complete description of the technical solutions in the embodiments of the present invention is made below in combination with the drawings therein. Apparently, some, not all of the embodiments of the present invention will be described. All other embodiments, obtained by those of ordinary skill in the art based on the embodiments of the present invention without creative efforts, are within the scope of the present invention.

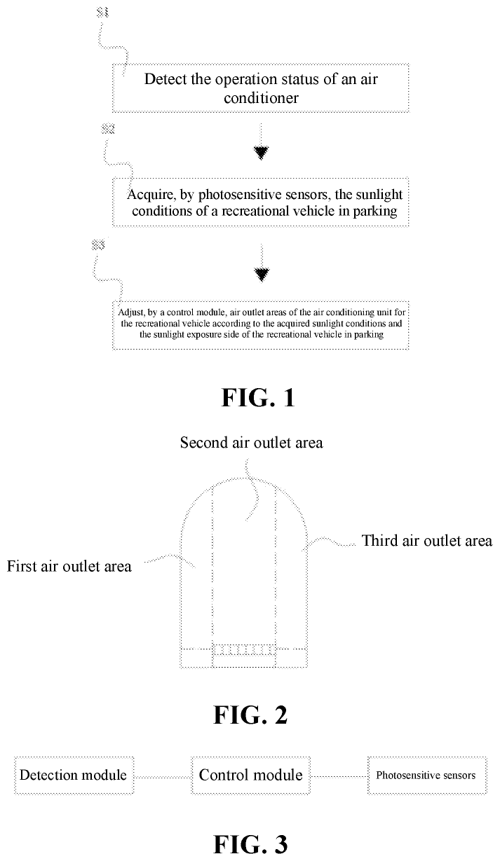

FIG. 1 is a flow chart of the control method of an air conditioning unit for a recreational vehicle according to an embodiment of the present invention. As shown in FIG. 1, the control method of an air conditioning unit for a recreational vehicle includes the following steps: S1. An operation status of the air conditioner is detected, that is to say, the air conditioning unit for the recreational vehicle is started or stopped by detecting the operation status of the air conditioner.

For example, when the air conditioning unit for the recreational vehicle detects that the air conditioner is operated in a refrigeration status, the air conditioning unit for the recreational vehicle is started to enter step S2; and when the air conditioning unit for the recreational vehicle detects that the air conditioner is operated in a heating status, the air conditioning unit for the recreational vehicle does not enter step S2.

S2. Photosensitive sensors acquire sunlight conditions of the recreational vehicle in parking, that is to say, when the air conditioner is started, after detecting that the air conditioner is in a refrigeration status, the air conditioning unit for the recreational vehicle will start to acquire the sunlight conditions of the recreational vehicle in parking through three photosensitive sensors disposed on the roof of the recreational vehicle.

S3. A control module adjusts air outlet areas of the air conditioning unit for the recreational vehicle according to the acquired sunlight conditions and the sunlight exposure side of the recreational vehicle in parking.

Specifically, the air conditioning unit for the recreational vehicle is started after a refrigeration status is detected. In the operation process of the air conditioning unit for the recreational vehicle, the photosensitive sensors start to acquire the sunlight conditions of the recreational vehicle in parking, and the control module will adjust the air outlet areas of the air conditioner according to the acquired sunlight conditions and the sunlight exposure side, and can preset a time interval, where the preset time interval is 1 min.

The photosensitive sensors are divided into a first photosensitive sensor, a second photosensitive sensor and a third photosensitive sensor.

FIG. 2 is a schematic diagram illustrating the air outlet areas in the control method of an air conditioning unit for a recreational vehicle according to the present invention. As shown in FIG. 2, the air outlet coverage of the air conditioning unit for the recreational vehicle is divided into a first air outlet area, a second air outlet area and a third air outlet area.

Specifically, the first photosensitive sensor is located above the vehicle roof in the first air outlet area, the second photosensitive sensor is located above the vehicle roof in the second air outlet area, and the third photosensitive sensor is located above the vehicle roof in the third air outlet area.

The step S1 specifically includes: refrigerating, by the air conditioning unit for the recreational vehicle, the second air outlet area first when the air conditioning unit for the recreational vehicle detects that the air conditioner is in refrigeration.

Specifically, the air conditioning unit for the recreational vehicle refrigerates the second air outlet area first when the air conditioning unit for the recreational vehicle is started and detects that the air conditioner is operated in a refrigeration status.

According to one embodiment of the present invention, the first photosensitive sensor is located in the first air outlet area, the second photosensitive sensor is located in the second air outlet area, and the third photosensitive sensor is located in the third air outlet are, where the step S3 specifically includes: controlling, by the control module, the air conditioning unit for the recreational vehicle to refrigerate the first air outlet area when the resistance value of the first photosensitive sensor is the smallest, which indicates that the sunlight exposure side of the recreational vehicle is on the first photosensitive sensor; controlling, by the control module, the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and controlling, by the control module, the air conditioning unit for the recreational vehicle to refrigerate the third air outlet area when the resistance value of the third photosensitive sensor is the smallest, which indicates that the sunlight exposure side of the recreational vehicle is on the third photosensitive sensor.

Specifically, in the operation process of the air conditioning unit for the recreational vehicle, the control module will judge which side of the recreational vehicle is a sunlight exposure side according to the resistance values acquired by the photosensitive sensors, so as to adjust the air outlet areas of the air conditioning unit for the recreational vehicle.

For example, when R1>R2>R3, air outlet refrigeration is performed on the side with the third air outlet area where the third photosensitive sensor is located; when R1>R2=R3, refrigeration is maintained in the current air outlet area; when R2<R1=R3, air outlet refrigeration is performed in the second air outlet area where the second photosensitive sensor is located; when R1<R2<R3, air outlet refrigeration is performed on the side with the first air outlet area where the first photosensitive sensor is located; and when R1=R2<R3, the current air outlet switching position is kept unchanged.

In conclusion, in the control method of an air conditioning unit for a recreational vehicle according to the embodiment of the present invention, the air conditioning unit for the recreational vehicle first detects that the air conditioner is in a refrigeration state, then acquires the sunlight conditions of the recreational vehicle in parking by the photosensitive sensors, and finally adjusts the air outlet areas of the air conditioning unit for the recreational vehicle according to the acquired sunlight conditions and the sunlight exposure side of the recreational vehicle in parking by using the control module. Thus, in the present invention, the refrigeration air outlet direction of the air conditioner for the recreational vehicle can be controlled according to the sunlight direction of the recreational vehicle in parking, so as to achieve purposes of quickly balancing the temperature in the recreational vehicle and quickly reducing the temperature, thereby improving the comfort of the recreational vehicle users.

FIG. 3 is a schematic diagram illustrating the structure of the air conditioning unit for the recreational vehicle according to an embodiment of the present invention. As shown in FIG. 3, the air conditioning unit for the recreational vehicle includes a detection module, photosensitive sensors and a control module.

The detection module is configured to detect the working status of the air conditioner; the photosensitive sensors are configured to acquire the sunlight conditions of the recreational vehicle; and the control module is configured to adjust the air outlet areas of the air conditioning unit for the recreational vehicle according to the working status of the air conditioning unit and the sunlight conditions acquired by the photosensitive sensors.

The control module is connected to the photosensitive sensors and the detection module.

Specifically, the air conditioning unit for the recreational vehicle is started after a refrigeration status is detected. In the operation process of the air conditioning unit for the recreational vehicle, the photosensitive sensors start to acquire the sunlight conditions of the recreational vehicle in parking, and the control module will adjust the air outlet areas of the air conditioner according to the acquired sunlight conditions and the sunlight exposure side, and can preset a time interval, where the preset time interval is 1 min.

The photosensitive sensors are divided into a first photosensitive sensor, a second photosensitive sensor and a third photosensitive sensor; and the air outlet coverage of the air conditioning unit for the recreational vehicle is divided into a first air outlet area, a second air outlet area and a third air outlet area.

The air conditioning unit for the recreational vehicle refrigerates the second air outlet area first when the air conditioning unit for the recreational vehicle detects that the air conditioner is in refrigeration.

According to one embodiment of the present invention, the first photosensitive sensor is located in the first air outlet area, the second photosensitive sensor is located in the second air outlet area, and the third photosensitive sensor is located in the third air outlet are, where the step S3 specifically includes: controlling, by the control module, the air conditioning unit for the recreational vehicle to refrigerate the first air outlet area when the resistance value of the first photosensitive sensor is the smallest, which indicates that the sunlight exposure side of the recreational vehicle is on the first photosensitive sensor; controlling, by the control module, the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and controlling, by the control module, the air conditioning unit for the recreational vehicle to refrigerate the third air outlet area when the resistance value of the third photosensitive sensor is the smallest, which indicates that the sunlight exposure side of the recreational vehicle is on the third photosensitive sensor.

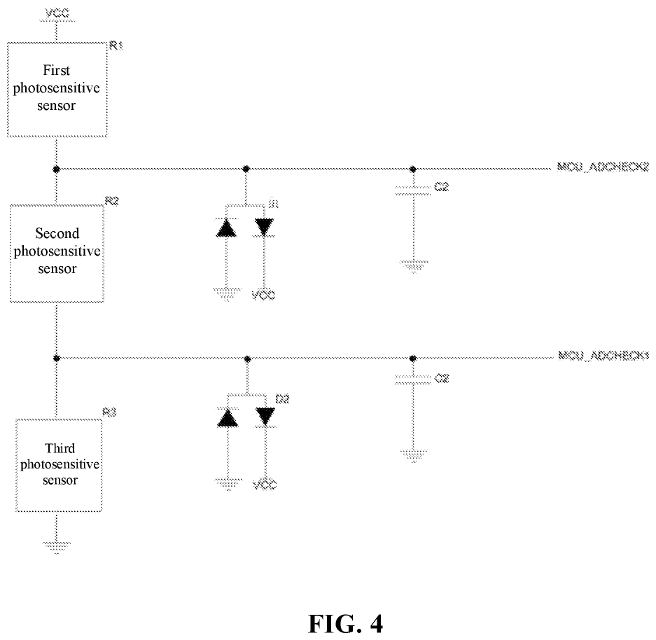

In brief, as shown in FIG. 4, the resistors of the three photosensitive sensors are connected in series, with the head and the tail connected to the power supply; through single-chip voltage detection ports AD_CHECK1 and AD_CHECK2: when VCC−AD_CHECK2>AD_CHECK2−AD_CHECK1>AD_CHECK1, R3 has the smallest resistance, the third photosensitive sensor R3 has the strongest intensity of illumination, and the air outlet is switched toward the third air outlet area where R3 is located for air outlet refrigeration; when VCC−AD_CHECK2>AD_CHECK1>AD_CHECK2−AD_CHECK1, R2 has the smallest resistance, the second photosensitive sensor R2 has the strongest intensity of illumination, and the air outlet is switched toward the second air outlet area where R2 is located for air outlet refrigeration; when VCC−AD_CHECK2<AD_CHECK2−AD_CHECK1<AD_CHECK1, R1 has the smallest resistance, the first photosensitive sensor R1 has the strongest intensity of illumination, and the air outlet is switched toward the first air outlet area where R1 is located for air outlet refrigeration; since the photoresistors are located on the vehicle roof and the circuit board is located in the vehicle, a relatively long circuit is needed for leading the sensors to the vehicle roof, and D1 and D2 are used for voltage clamping to protect the chip while C1 and C2 are used for filtering to stabilize the voltage and prevent interference. Air outlet switch guiding is controlled by a common stepping motor; the angular position is determined by limiting; and the actual position is worked out with actual operation steps, so as to determine the air outlet switch guiding angle.

In summary, in the embodiment of the present invention, a user detects the operation status of the air conditioner through an acquisition module; when the air conditioner is operated in a refrigeration mode, the photosensitive sensors acquire the sunlight conditions of the recreational vehicle in parking; and the control module will adjust and control the air outlet areas according to the sunlight conditions acquired by the photosensitive sensors.

To sum up, the control module of the air conditioning unit provided according to the embodiment of the present invention adjusts the air outlet areas of the air conditioning unit according to the operation status of the air conditioner detected by the acquisition module and in combination with the sunlight conditions acquired by the photosensitive sensors in a refrigeration mode. Thus, by controlling the air outlet areas, the device can reduce the temperature of the recreational vehicle in a timely manner and quickly cool the area in need of fast cooling, and also can achieve an effect of quickly balancing the temperature in the recreational vehicle, thereby improving the user's sense of comfort, and effectively avoiding manual adjustment of the air direction of the air conditioning unit by the user using a remote control; and meanwhile, the energy consumption of the air conditioning unit can be lowered to save energy sources.

In the descriptions of this Specification, the descriptions of reference terminologies such as “one embodiment”, “some embodiments”, “example”, “specific example” or “some examples” mean that specific features, structures, materials or characteristics described by the embodiment or example are included in at least one embodiment or example of the present invention. In this Specification, schematic representations of the above terminologies are not necessarily targeted at the same embodiment or example. Moreover, the specific features, structures, materials or characteristics described can be integrated in an appropriate manner in any one or more embodiments or examples. In addition, without mutual contradiction, those skilled in the art can integrate and combine different embodiments or examples as well as the features of different embodiments or examples described in this Specification.

In addition, the terminologies “first” and “second” are only used for the purpose of description, and cannot be interpreted as indicating or implying the relative importance or implicitly specifying the quantity of the indicated technical features. Therefore, the features defined with “first” and “second” may explicitly or implicitly include at least one of such features. In the description of the present invention, unless otherwise specifically defined, “a plurality of” means at least two, for example, two, three, etc.

Although the embodiments of the present invention have been displayed and described, those of ordinary skill in the art can understand that many changes, modifications, substitutions and variations can be made to these embodiments without departing from the principles and spirit of the present invention; and the scope of the present invention is defined by the attached claims and equivalents thereof.

What is claimed is:

1. A control method of an air conditioning unit for a recreational vehicle, comprising the following steps:
S1. detecting an operation status of an air conditioner;
S2. acquiring, by photosensitive sensors, sunlight conditions of the recreational vehicle in parking; and
S3. adjusting, by a control module, air outlet areas of the air condition conditioning unit for the recreational vehicle according to the acquired sunlight conditions and a sunlight exposure side of the recreational vehicle in parking.

2. The control method of an air conditioning unit for a recreational vehicle according to claim 1, wherein the photosensitive sensors are divided into a first photosensitive sensor, a second photosensitive sensor and a third photosensitive sensor.

3. The control method of an air conditioning unit for a recreational vehicle according to claim 1, wherein the air outlet coverage of the air condition conditioning unit for the recreational vehicle is divided into a first air outlet area, a second air outlet area and a third air outlet area.

4. The control method of an air conditioning unit for a recreational vehicle according to claim 1, wherein the step Si specifically comprises: refrigerating the second air outlet area first by the air condition conditioning unit for the recreational vehicle when the air condition conditioning unit for the recreational vehicle detects that the air conditioner is in refrigeration.

5. The control method of an air conditioning unit for a recreational vehicle according to claim 1, wherein the first photosensitive sensor is located in the first air outlet area, the second photosensitive sensor is located in the second air outlet area, and the third photosensitive sensor is located in the third air outlet are, wherein the step S3 specifically comprises:
controlling, by the control module, the air conditioning unit for the recreational vehicle to refrigerate the first air outlet area when the resistance value of the first photosensitive sensor is the smallest, which indicates that the sunlight exposure side of the recreational vehicle is on the first photosensitive sensor;
controlling, by the control module, the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and
controlling, by the control module, the air conditioning unit for the recreational vehicle to refrigerate the third air outlet area when the resistance value of the third photosensitive sensor is the smallest, which indicates that the sunlight exposure side of the recreational vehicle is on the third photosensitive sensor.

6. An air conditioning unit for a recreational vehicle, comprising:
a detection module, configured to detect an operation status of an air conditioner for a recreational vehicle;
photosensitive sensors, configured to acquire sunlight conditions of the recreational vehicle in parking; and
a control module, configured to adjust air outlet areas of the air conditioning unit for the recreational vehicle according to a sunlight exposure side and the sunlight conditions of the recreational vehicle acquired by the photosensitive sensors.

7. The air conditioning unit for a recreational vehicle according to claim 6, wherein the control module is connected to the photosensitive sensors and the detection module.

8. The air conditioning unit for a recreational vehicle according to claim 6, wherein the photosensitive sensors are divided into a first photosensitive sensor, a second photosensitive sensor and a third photosensitive sensor.

9. The air conditioning unit for a recreational vehicle according to claim 6, wherein the air outlet coverage of the air conditioning unit for the recreational vehicle is divided into a first air outlet area, a second air outlet area and a third air outlet area.

10. The air conditioning unit for a recreational vehicle according to claim 6, wherein the first photosensitive sensor is located in the first air outlet area, the second photosensitive sensor is located in the second air outlet area, and the third photosensitive sensor is located in the third air outlet are, wherein the control module controls the air conditioning unit for the recreational vehicle to refrigerate the first air outlet area when the resistance value of the first photosensitive sensor is the smallest, which indicates that the sunlight exposure side of the recreational vehicle is on the first photosensitive sensor;
the control module controls the air conditioning unit for the recreational vehicle to refrigerate the second air outlet area when the resistance value of the second photosensitive sensor is the smallest, which indicates that the sunlight exposure side of the recreational vehicle is on the second photosensitive sensor; and
the control module controls the air conditioning unit for the recreational vehicle to refrigerate the third air outlet area when the resistance value of the third photosensitive sensor is the smallest, which indicates that the sunlight exposure side of the recreational vehicle is on the third photosensitive sensor.
